(19) United States
(12) Patent Application Publication
(10) Pub. No.: US 2014/0170407 A1
(43) Pub. Date: Jun. 19, 2014

(54) ANTICORROSION AGENTS FOR TRANSPARENT CONDUCTIVE FILM

(71) Applicant: Carestream Health, Inc., Rochester, NY (US)

(72) Inventors: Chaofeng Zou, Maplewood, MN (US); Haiyun Lu, Woodbury, MN (US); James B. Philip, JR., Fort Myers, FL (US)

(21) Appl. No.: 14/088,829

(22) Filed: Nov. 25, 2013

Related U.S. Application Data
(60) Provisional application No. 61/736,563, filed on Dec. 13, 2012.

(51) Int. Cl. H01B 1/22; H01B 13/00

(52) U.S. Cl. CPC H01B 1/22; H01B 13/0036
USPC 428/301.1; 427/108

(57) ABSTRACT

Certain mercapotetrazoles and mercaptotriazoles have been found to provide anti-corrosion properties when incorporated into silver nanowire containing films. The effectiveness of such compounds may be enhanced by their introduction into a layer disposed adjacent to a silver nanowire containing layer.

### CROSS-REFERENCE TO RELATED APPLICATIONS

This application claims the benefit of U.S. Provisional Application No. 61/736,563, filed Dec. 13, 2012, entitled ANTICORROSION AGENTS FOR TRANSPARENT CONDUCTIVE FILM, which is hereby incorporated by reference in its entirety.

### BACKGROUND

Transparent and conductive films (TCF) have been used extensively in recent years in applications such as touch panel displays, liquid crystal displays, electroluminescent lighting, organic light-emitting diode devices, and photovoltaic solar cells. Indium tin oxide (ITO) based transparent conductive film has been the transparent conductor-of-choice for most applications due to its high conductivity, transparency, and relatively good stability. However, indium tin oxide based transparent conductive films have limitations due to the high cost of indium, the need for complicated and expensive vacuum deposition equipment and processes, and indium tin oxide's inherent brittleness and tendency to crack, especially when it is deposited on flexible substrates.

Two of the most important parameters for measuring the properties of transparent conductive films are total light transmittance (% T) and film surface electric conductivity. Higher light transmittance allows clear picture quality for display applications, higher efficiency for lighting and solar energy conversion applications. Lower resistivity is most desirable for most transparent conductive films applications in which power consumption can be minimized. Therefore, the higher the T/R ratio of the transparent conductive films is, the better the transparent conductive films are.

U.S. Patent Application Publication 2006/0257638A1 describes a transparent conductive film comprising carbon nanotubes (CNT) and vinyl chloride resin polymer binder.

U.S. Pat. No. 8,049,333 and U.S. Patent Application Publication 2008/0286447A1 describe a transparent conductive film in which silver nanowires are deposited onto a substrate to form a bare nanowire network followed by overcoating the silver nanowire network with a polymer matrix material to form a transparent conductive film. The polymer materials such as polyacrylates and carboxyl alkyl cellulose ether polymers were suggested as useful materials for the matrix.

US Patent Application Publication 2008/0286447A1 suggests the use of aromatic triazoles and other nitrogen containing compounds as corrosion inhibitors for silver nanowire based transparent conductors. Long chain alkylthio compounds have also been suggested as useful corrosion inhibitors.

U.S. Patent Application Publication 2008/0292979A1 describes a transparent conductive film comprising silver nanowires, or a mixture of silver nanowires and carbon nanotubes. The transparent conductive network is formed either without polymer binder or in a photoimageable composition. The transparent and conductive films were coated on both glass and polyethylene terephthalate (PET) supports.

U.S. Pat. No. 8,052,773 discloses a transparent conductive film which is formed from coating of silver nanowires to form a network followed by overcoating with a layer of urethane acrylate polymer.

U.S. Patent Application Publication 2011/0024159A1 discloses use of corrosion inhibitors in an overcoat layer of a transparent conductive film.

PCT Patent Publication WO 2011/115603A1 discloses anticorrosion agents comprising 1,2-diazine compounds for use in transparent conductive films.

US Patent Application Publication 2010/0307792A1 discloses addition of coordination ligands with silver nanowire aqueous dispersion to form sediments followed by separation of such sediments from the supernatant containing halide ions before apply such silver nanowire dispersion in the coating and formation of TCF.

European Patent Publication EP2251389A1 discloses a silver nanowire (AgNW) based ink formulation in which various aqueous silver complex ions were added into silver nanowire based ink in a ratio of complex ion to AgNW of no more than 1:64 (w:w).

### SUMMARY

Certain mercaptotetrazoles or mercaptotriazoles are particularly useful as anticorrosion agents for the stabilization of a network of silver nanowire-based transparent conductive films toward the undesirable reaction of such conductive films with corrosive agents such as hydrogen sulfide.

We have discovered that the effectiveness of such mercaptotetrazoles or mercaptotriazoles may be enhanced by their introduction in at least one coating mix for at least one layer disposed adjacent to the at least one layer comprising silver nanowires. Such a layer might be an overcoat or topcoat layer, if disposed on the at least one layer comprising silver nanowires. Such an overcoat or topcoat layer may, for example, be thermally cured or UV cured. Alternatively, such a layer might be a primer or undercoat layer, if disposed between the at least one layer comprising silver nanowires and the transparent support. Or the mercaptotetrazoles or mercaptotriazoles might be included in layers both above and below that at least one layer comprising silver nanowires. In any of these cases, the mercaptotetrazoles or mercaptotriazoles, optionally, also be added to at least one of the layers comprising silver nanowires.

At least a first embodiment provides a transparent conductive article comprising a transparent support; at least one first layer disposed on the transparent support, the at least one first layer comprising a network of silver nanowires dispersed within at least one polymer binder; and at least one second layer disposed on the at least one first layer, the at least one second layer comprising one or more anticorrosion agents comprising at least one mercaptotetrazole or mercaptotriazole.

In at least some such embodiments, the at least one mercaptotetrazole comprises at least one compound having the general structure (I):

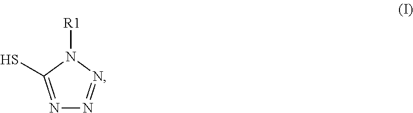

wherein R1 is one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, an amino group (NR₂R₃) where R₂ and R₃ are independently a hydrogen, an alkyl group comprising up to 20 carbon atoms, or an aryl group comprising up to 10 carbon atoms, a thioether group (SR₄) where R₄ is an alkyl group comprising up to 20 carbon atoms, or an aryl group comprising up to 10 carbon atoms, a sulfoxy group (SOR₄), a sulfone group (SO₂R₄), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₂R₃), an acylamino group (NR₂COR₄), an acyl group (COR₄), an acyloxy group (OCOR₄), or a sulfonamido group (SO₂NR₂R₃). An exemplary mercaptotetrazole is 1-phenyl-1H-tetrazole-5-thiol, which has the structure (II):

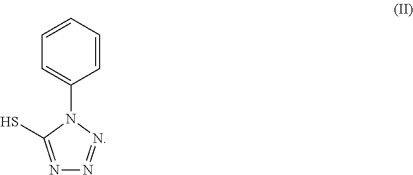 [SMILES: Sc1nnnn1-c1ccccc1]

In at least some such embodiments, the at least one mercaptotriazole comprises at least one 1,2,4-mercaptotriazole.

In at least some such embodiments, the at least one mercaptotriazole comprises at least one compound having the general structure (III):

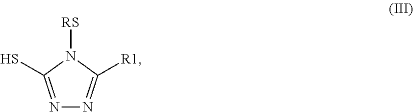

wherein R1 and R2 are independently one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, an amino group (NR₃R₄) where R₃ and R₄ are independently a hydrogen, an alkyl group comprising up to 20 carbon atoms, or an aryl group comprising up to 10 carbon atoms, a thioether group (SR₅) where R₅ is an alkyl group comprising up to 20 carbon atoms, or an aryl group comprising up to 10 carbon atoms, a sulfoxy group (SOR₅), a sulfone group (SO₂R₅), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₃R₄), an acylamino group (NR₄COR₅), an acyl group (COR₅), an acyloxy group (OCOR₅), or a sulfonamido group (SO₂NR₃R₄). Exemplary mercaptotriazoles are 4-benzyl-1,2,4-triazole-3-thiol, having structure (IV):

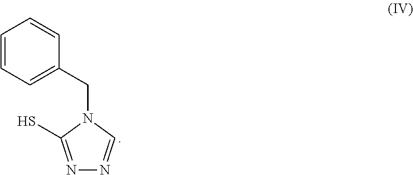 [SMILES: Sc1nncn1Cc1ccccc1]

and 4-benzyl-5-hydroxymethyl-1,2,4-triazole-3-thiol, having structure (V):

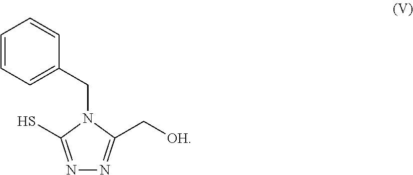 [SMILES: OCc1nnc(S)n1Cc1ccccc1]

In at least some such embodiments, the silver nanowires are present in an amount sufficient to provide a surface resistivity of less than 1000 ohm/sq.

In at least some such embodiments, the silver nanowires have an aspect ratio of from about 20 to about 3300.

In at least some such embodiments, the silver nanowires are present in an amount of from about 10 mg/m² to about 500 mg/m².

In at least some such embodiments, the transparent conductive article exhibits a transmittance of at least 80% across entire spectrum range of from about 350 nm to about 1100 nm and a surface resistivity of 500 ohm/sq or less.

In at least some such embodiments, the at least one polymer binder comprises at least one water soluble polymer. Exemplary water soluble polymers are gelatin, polyvinyl alcohol, or mixtures thereof. In some cases, the such polymer binders may further comprise up to 50 wt % of one or more additional water soluble polymers, such as, for example, a polyacrylic polymer.

In at least some such embodiments, the at least one polymer binder comprises at least one organic solvent soluble polymer, such as, for example, at least one cellulose ester polymer. Exemplary cellulose ester polymers are cellulose acetate, cellulose acetate butyrate, cellulose acetate propionate, or mixtures thereof. In at least some cases, the at least one cellulose ester polymer may have a glass transition temperature of at least 100° C. In at least some cases, the at lease one polymer binder further comprises up to 50 wt % of one or more additional organic solvent soluble polymers, such as, for example, a polyester polymer.

At least a second embodiment provides methods comprising applying at least one first coating mixture onto a transparent support to form at least one first coated layer, the at least one first coating mixture comprising silver nanowires and at least one polymer binder; and applying at least one second coating mixture onto the at least one first coated layer to form at least one second coated layer, the at least one second coating mixture comprising at least one mercaptotetrazole or mercaptotriazole.

In at least some such embodiments, the applying the at least one first coating mixture and the applying the at least one second coating mixture occur simultaneously.

In at least some such embodiments, the methods may further comprise drying the at least one first layer or the at least one second layer or both.

At least a third embodiment provides methods comprising applying at least one first coating mixture onto a transparent support to form at least one first coated layer, the at least one first coating mixture comprising at least one mercaptotetrazole or mercaptotriazole; and applying at least one second coating mixture onto the at least one first coated layer to form at least one second coated layer, the at least one second coating mixture comprising silver nanowires and at least one polymer binder.

In at least some such embodiments, the applying the at least one first coating mixture and the applying the at least one second coating mixture occur simultaneously.

In at least some such embodiments, the methods may further comprise drying the at least one first layer or the at least one second layer or both.

These embodiments and other variations and modifications may be better understood from the description, exemplary embodiments, examples, and claims that follow. Any embodiments provided are given only by way of illustrative example. Other desirable objectives and advantages inherently achieved may occur or become apparent to those skilled in the art.

### DESCRIPTION

All publications, patents, and patent documents referred to in this document are incorporated by reference in their entirety, as though individually incorporated by reference.

U.S. Provisional Application No. 61/736,563, filed Dec. 13, 2012, entitled ANTICORROSION AGENTS FOR TRANSPARENT CONDUCTIVE FILM, is hereby incorporated by reference in its entirety.

### DEFINITIONS

The terms “conductive layer” or “conductive film” refer to the network layer comprising silver nanowires dispersed within a polymer binder.

The term “conductive” refers to electrical conductivity.

The term “article” refers to the coating of a “conductive layer” or “conductive film” on a support.

The terms “coating weight,” “coat weight,” and “coverage” are synonymous, and are usually expressed in weight or moles per unit area such as g/m² or mol/m².

The term “transparent” means capable of transmitting visible light without appreciable scattering or absorption.

“Haze” is wide-angle scattering that diffuses light uniformly in all directions. It is the percentage of transmitted light that deviates from the incident beam by more than 2.5 degrees on the average. Haze reduces contrast and results in a milky or cloudy appearance. Materials having lower haze percentages appear less hazy than those having higher haze percentages.

The term “organic solvent” means “a material, liquid at use temperature, whose chemical formula comprises one or more carbon atoms.”

The term “aqueous solvent” means a material, liquid at use temperature, whose composition in a homogeneous solution comprises water in the greatest proportion (i.e., at least 50 percent water by weight).

The term “water soluble” means the solute forms a homogenous solution with water, or a solvent mixture in which water is the major component.

The terms “a” or “an” refer to “at least one” of that component (for example, the anticorrosion agents, nanowires, and polymers described herein).

Furthermore, all publications, patents, and patent documents referred to in this document are incorporated by reference herein in their entirety, as though individually incorporated by reference.

### Introduction

In order for silver based transparent conductors to have practical use it is important that these silver based transparent conductors be stable for a long period when subjected to environmental conditions.

Any atmospheric corrosion due to the reaction of low levels of chemicals in the air will induce undesirable chemical reactions at the metal nanowire surface, impacting the conductivity and performance of the metal nanowire based transparent conductors. It is well known that corrosion, or “tarnishing,” may readily occur on silver metal surfaces when exposed to the atmosphere. Without wishing to be bound by theory, one example of such a tarnishing mechanism is sulfidation of silver surface by reaction of hydrogen sulfide with silver:

2Ag+H₂S→Ag₂S+H₂ Eq. 1

Because the electric conductivity of silver compounds such as silver sulfide is much lower than that of silver metal, silver nanowire based conductors can gradually lose conductivity when exposed to the atmosphere.

In contrast to bare metal wires exposed to the air, silver nanowires in a polymer matrix are more stable since the presence of the polymer slows down the diffusion of hydrogen sulfide (or other corrosive agents) to the silver nanowire surface. Nevertheless, it is important to stabilize the silver nanowire surface to prevent the sulfidation process, even when the nanowires are embedded in a polymer matrix.

In contrast to bare metal wires exposed to the air, silver nanowires in a polymer matrix are more stable since the presence of the polymer slows down the diffusion of hydrogen sulfide (or other corrosive agents) to the silver nanowire surface. Nevertheless, it is important to stabilize the silver nanowire surface to prevent the sulfidation process, even when the nanowires are embedded in a polymer matrix.

It is further believed that during the silver nanowire (AgNW) synthesis process, the surface of AgNW is contaminated with small amount of silver halide species (AgX, X=Cl, Br, F, I) due to the use of halide salt as catalysts in most of known AgNW synthesis processes, or due to low level of halide salts commonly exist in solvent and other raw material for AgNW synthesis. Without wishing to be bound by theory, the silver halide species may undergo photolysis:

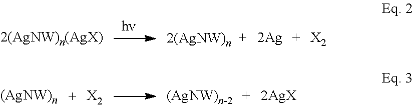

Under normal exposure of the TCF to ambient light, the chemical reactions represented by Equations 2 and 3 therefore could proceed until a sufficient fraction of AgNW crystals are converted into non-conductive species to result in an increase in TCF resistivity.

It would be useful to find anticorrosion agents for transparent electrically conductive films comprising a network of silver nanowires in polymer binder(s) that can be coated from aqueous or from organic solvents, using common coating techniques.

### Silver Nanowires

The silver nanowires are an essential component for imparting electrical conductivity to the conductive films, and to the articles prepared using the conductive films. The electrical conductivity of the silver nanowire based transparent conductive film is mainly controlled by a) the conductivity of a single nanowire, b) the number of nanowires between the terminals, and c) the connectivity and contact resistivity between the nanowires. Below a certain nanowire concentration (also referred as the percolation threshold), the conductivity between the terminals is zero, as there is no continuous current path provided because the nanowires are spaced too far apart. Above this concentration, there is at least one current path available. As more current paths are provided, the overall resistance of the layer will decrease. However, as more current paths are provided, the clarity (i.e., percent light transmission) of the conductive film decreases due to light absorption and back scattering by the nanowires. Also, as the amount of silver nanowires in the conductive film increases, the haze of the transparent film increases due to light scattering by the silver nanowires. Similar effects will occur in transparent articles prepared using the conductive films.

In one embodiment, the silver nanowires have aspect ratio (length/width) of from about 20 to about 3300. In another embodiment, the silver nanowires have an aspect ratio (length/width) of from about 500 to 1000. Silver nanowires having a length of from about 5 μm to about 100 μm (micrometer) and a width of from about 10 nm to about 200 nm are useful. Silver nanowires having a width of from about 20 nm to about 100 nm and a length of from about 10 μm to about 50 μm are also particularly useful for construction of a transparent conductive network film.

Silver nanowires can be prepared by known methods in the art. In particular, silver nanowires can be synthesized through solution-phase reduction of a silver salt (e.g., silver nitrate) in the presence of a polyol (e.g., ethylene glycol or propylene glycol) and poly(vinyl pyrrolidone). Large-scale production of silver nanowires of uniform size can be prepared according to the methods described in, e.g., Ducamp-Sanguesa, C. et al, J. of Solid State Chemistry, (1992), 100, 272-280; Sun, Y. et al., Chem. Mater (2002), 14, 4736-4745, Sun, Y. et al., Nano Letters, (2003), 3(7), 955-960; US Patent Application Publication 2012/0063948, published Mar. 15, 2012; US patent application publication 2012/0126181, published May 24, 2012; US patent application publication 2012/0148436, published Jun. 14, 2012; US Patent Application Publication 2012/0207644, published Aug. 16, 2012; and U.S. patent application Ser. No. 13/439,983, filed Apr. 5, 2012, entitled “NANOWIRE PREPARATION METHODS, COMPOSITIONS, AND ARTICLES,” each of which is incorporated by reference in its entirety.

### Polymer Binders

For a practical manufacturing process for transparent conductive films, it is important to have both the conductive components, such as silver nanowires, and a polymer binder in a coating solution. The polymer binder solution serves a dual role, as dispersant to facilitate the dispersion of silver nanowires and as a viscosifier to stabilize the silver nanowire coating dispersion so that the sedimentation of silver nanowires does not occur at any point during the coating process. It is also desirable to have the silver nanowires and the polymer binder in a single coating dispersion. This simplifies the coating process and allows for a one-pass coating, and avoids the method of first coating bare silver nanowires to form a weak and fragile film that is subsequently over-coated with a polymer to form the transparent conductive film.

In order for a transparent conductive film to be useful in various device applications, it is also important for the polymer binder of the transparent conductive film to be optically transparent and flexible, yet have high mechanical strength, good hardness, high thermal stability, and light stability. This requires polymer binders to be used for transparent conductive film to have Tg (glass transition temperature) greater than the use temperature of the transparent conductive film.

Transparent, optically clear polymer binders are known in the art. Examples of suitable polymeric binders include, but are not limited to: polyacrylics such as polymethacrylates (e.g., poly(methyl methacrylate)), polyacrylates and polyacrylonitriles, polyvinyl alcohols, polyesters (e.g., polyethylene terephthalate (PET), polybutylene terephthalate, and polyethylene naphthalate), polymers with a high degree of aromaticity such as phenolics or cresol-formaldehyde (Novolacs®), polystyrenes, polyvinyltoluene, polyvinylxylene, polyimides, polyamides, polyamideimides, polyetheramides, polysulfides, polysulfones, polyphenylenes, and polyphenyl ethers, polyurethane (PU), polycarbonates, epoxy, polyolefins (e.g. polypropylene, polymethylpentene, and cyclic olefins), acrylonitrile-butadiene-styrene copolymer (ABS), cellulosics, silicones and other silicon-containing polymers (e.g. polysilsesquioxanes and polysilanes), polyvinylchloride (PVC), polyvinylacetates, polynorbornenes, synthetic rubbers (e.g. EPR, SBR, EPDM), and fluoropolymers (e.g., polyvinylidene fluoride, polytetrafluoroethylene (TFE) or polyhexafluoropropylene), copolymers of fluoro-olefin and hydrocarbon olefin (e.g., Lumiflon®), and amorphous fluorocarbon polymers or copolymers (e.g., CYTOP® by Asahi Glass Co., or Teflon® AF by Du Pont), polyvinylbutryals, polyvinylacetals, gelatins, polysaccharides, and starches.

In certain embodiments, in order to disperse and stabilize silver nanowires in polymeric coating solution, the use of polymer binders having high oxygen content is advantageous. Oxygen-containing groups, such as hydroxyl group and carboxylate groups have a strong affinity for binding to the silver nanowire surface and facilitate the dispersion and stabilization. Many oxygen-rich polymers also have good solubility in the polar organic solvents commonly used to prepare organic solvent-coated materials, while other oxygen-rich polymers have good solubility in water or the aqueous solvent mixtures commonly used to prepare aqueous solvent-coated materials.

In certain embodiments, cellulose ester polymers, such as cellulose acetate butyrate (CAB), cellulose acetate (CA), or cellulose acetate propionate (CAP) are superior to other oxygen-rich polymer binders when used to prepare silver nanowire based transparent conductive films that are coated from organic solvents such as 2-butanone (methyl ethyl ketone, MEK), methyl iso-butyl ketone, acetone, methanol, ethanol, 2-propanol, ethyl acetate, propyl acetate, butyl acetate, or mixtures thereof. Their use results in transparent conductive films in which both the optical light transmittance and electrical conductivity of the coated films are greatly improved. In addition, these cellulose ester polymers have glass transition temperatures of at least 100° C. and provide transparent, flexible films having high mechanical strength, good hardness, high thermal stability, and light stability.

The cellulose ester polymers can be present in from about 40 to about 90 wt % of the dried transparent conductive films. Preferably, they are present in from about 60 to about 85 wt % of the dried films. In some constructions, a mixture of a cellulosic ester polymer and one or more additional polymers may be used. These polymers should be compatible with the cellulosic polymer. By compatible is meant that a mixture comprising at least one cellulosic ester polymer and one or more additional polymers forms a transparent, single phase composition when dried. The additional polymer or polymers can provide further benefits such as promoting adhesion to the support and improving hardness and scratch resistance. As above, total wt % of all polymers is from about 40 to about 95 wt % of the dried transparent conductive films. Preferably, the total weight of all polymers is from about 60 to about 85 wt % of the dried films. Polyester polymers, urethanes, and polyacrylics are examples of additional polymers useful for blending with cellulosic ester polymers.

In other embodiments, water soluble polymer binders can also be used, such as polyvinyl alcohol, gelatin, polyacrylic acid, polyimides. Other water dispersible latex polymers can also be used such as polyacrylates and polymethacrylates containing methyl acrylic acid units. Coating from aqueous solutions benefits the environment and reduces the emission of volatile organic compounds during manufacturing.

The use of water soluble polymers, such as polyvinyl alcohol or gelatin as binders for silver nanowire based transparent conductors results in superior transparent conductive films in which both film transmittance and conductivity are greatly improved. Transparent conductive films prepared using either polyvinyl alcohol or gelatin polymer binders also show excellent clarity, scratch resistance, and hardness when polymer cross linkers are added to the polymer solution. Transparent conductive films prepared according to this invention provide transmittance of at least 80% across entire spectrum range of about 350 nm to about 1100 nm, and surface resistivity of 500 ohm/sq or less.

The transparent conductive articles comprising silver nanowires and water soluble polymer binders also show excellent clarity, high scratch resistance, and hardness. In addition, transparent conductive films prepared using these polymer binders have good adhesion to supports comprising polyethylene terephthalate (PET), poly(methylmethacrylate), polycarbonate, and the like, when an appropriate subbing layer is applied between the support and the conductive layer.

The water soluble polymer binders are present in from about 40 to about 95 wt % of the dried transparent conductive films. Preferably, they are present in from about 60 to about 85 wt % of the dried films.

In some constructions, up to 50 wt % of the gelatin or polyvinyl alcohol polymer binder can be replaced by one or more additional polymers. These polymers should be compatible with the gelatin or polyvinyl alcohol polymer binder. By compatible is meant that the all polymers form a transparent, single phase mixture when dried. The additional polymer or polymers can provide further benefits such as promoting adhesion to the support and improving hardness and scratch resistance. Water soluble acrylic polymers are particularly preferred as additional polymers. Examples of such polymers are polyacrylic acid and polyacrylamides, and copolymers thereof. As above, total wt % of all polymers is from about 50 to about 95 wt % of the dried transparent conductive films. Preferably, the total weight of all polymers is from about 70 to about 85 wt % of the dried films.

If desired, scratch resistance and hardness of the transparent conductive films with these polymer binders to the support can be improved by use of crosslinking agents to crosslink the polymer binders. Isocyanates, alkoxy silanes, and melamines are examples of typical crosslinking agents for cellulose ester polymers containing free hydroxyl groups. Vinyl sulfones and aldehydes are examples of typical crosslinking agents for gelatin binders.

### Anticorrosion Agents

Anticorrosion agents are chemical compounds that, when added to the transparent conductive film, improve the stability of the construction with respect to atmospheric corrosion caused by the reaction of oxygen or one or more other chemicals in the atmosphere with one or more components in the film. This reaction results in deterioration of the electric conductivity, optical properties, and/or physical integrity of the film. Anticorrosion agents should be colorless and odorless when used in the transparent conductive film, and should be stable to the conditions of heat, light, and humidity in the environment where transparent conductive film is used.

For a silver nanowire based conductive film, chemical compounds with functional group containing N, O, or S are potentially useful anticorrosion agents due to coordinating ability of these functional groups to the silver nanowire surfaces. Coordination is thought to complex with these compounds and passivate the silver surface to prevent the reaction of atmosphere gases with the silver surface. However, in practice, many such compounds, when bound to a silver nanowire surface, will drastically reduce the electric conductivity of the resultant conductive film. Apparently, the insulating effect of these compounds prevents electron “flow” at nanowire contact points. Therefore, it is important to identify a class of compounds that will provide anticorrosion protection to transparent conductive film without causing significant reduction in conductivity and other negative effects. Advantageously, delaying introduction of the anticorrosion agents into the conductive nanowire network until after its formation can minimize the destruction of conductive paths in the network.

Mercaptotetrazoles, Mercaptotriazoles, and their Tautomers

In at least some embodiments, anticorrosion compounds may comprise mercaptotetrazoles or mercaptotriazoles. It is well known that heterocyclic compounds exist in tautomeric forms. It should be understood that when mercaptotetrazoles or mercaptotriazoles are referred to or claimed in this application, their related tautomeric forms are also included in the reference or claim.

Both annular tautomerism and substituent tautomerism are possible. For example, for the 1,2,4-mercaptotriazoles, at least three annular tautomers are possible:

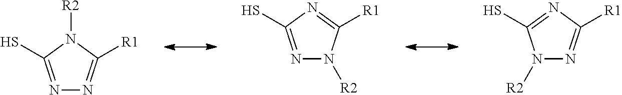

Similarly, for the mercaptotetrazoles, at least four annular tautomers are possible:

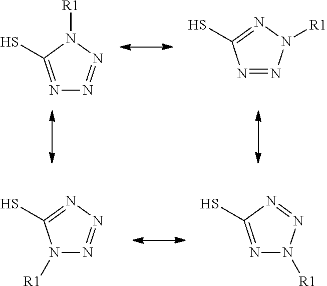

Thiole-thiene substituent tautomerism is also possible, where the labile hydrogen atom from the mercapto functional group becomes bonded to a nitrogen atom in the ring. This is illustrated for both the 1,2,4-mercaptotriazoles and the mercaptotetrazoles:

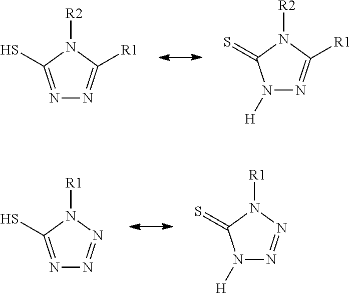

Interconversion among the tautomers can occur rapidly and individual tautomers are generally not isolatable, although particular tautomers may dominate. Accordingly, mercaptotriazoles and mercaptotetrazoles disclosed and claimed in this application will be understood to include their corresponding tautomers, including annular tautomers, substituent tautomers, or a combination of both.

### Anticorrosion Agents Comprising Mercaptotetrazoles or Mercaptotriazoles

In at least some embodiments, the anticorrosion compounds may comprise mercaptotetrazoles or mercaptotriazoles. In some cases, the anticorrosion compounds may comprise a mercaptotetrazole with Structure I:

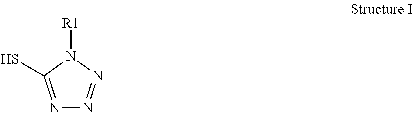

where R1 is one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, an amino group (NR₂R₃) where R₂ and R₃ are independently a hydrogen, an alkyl group comprising up to 20 carbon atoms, or an aryl group comprising up to 10 carbon atoms, a thioether group (SR₄) where R₄ is an alkyl group comprising up to 20 carbon atoms, or an aryl group comprising up to 10 carbon atoms, a sulfoxy group (SOR₄), a sulfone group (SO₂R₄), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₂R₃), an acylamino group (NR₂COR₄), an acyl group (COR₄), an acyloxy group (OCOR₄), or a sulfonamido group (SO₂NR₂R₃). An exemplary mercaptotetrazole is 1-phenyl-1H-tetrazole-5-thiol (PMT), which is shown in Structure II:

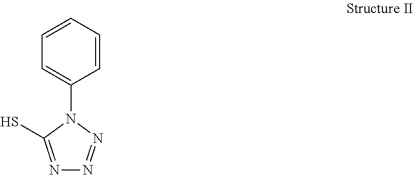 [SMILES: Sc1nnnn1-c1ccccc1]

In some cases, the anticorrosion compounds may comprise a 1,2,4-mercaptotriazole with Structure III:

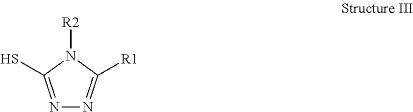

where wherein R1 and R2 are independently one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, an amino group (NR₃R₄) where R₃ and R₄ are independently a hydrogen, an alkyl group comprising up to 20 carbon atoms, or an aryl group comprising up to 10 carbon atoms, a thioether group (SR₅) where R₅ is an alkyl group comprising up to 20 carbon atoms, or an aryl group comprising up to 10 carbon atoms, a sulfoxy group (SOR₅), a sulfone group (SO₂R₅), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₃R₄), an acylamino group (NR₄COR₅), an acyl group (COR₅), an acyloxy group (OCOR₅), or a sulfonamido group (SO₂NR₃R₄). Exemplary 1,2,4-mercaptotriazoles are 4-benzyl-1,2,4-triazole-3-thiol (BHTT) with Structure IV:

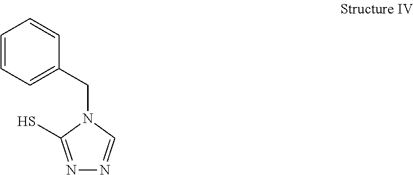 [SMILES: Sc1nncn1Cc1ccccc1]

and 4-benzyl-5-hydroxymethyl-1,2,4-triazole-3-thiol (BZTT) with Structure V:

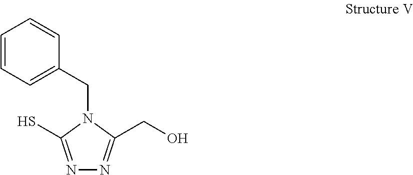 [SMILES: OCc1nnc(S)n1Cc1ccccc1]

### Coating of the Conductive Films

An organic solvent-based coating formulation for the transparent silver nanowire films can be prepared by mixing the various components with one or more polymer binders in a suitable organic solvent system that usually includes one or more solvents such as toluene, 2-butanone (methyl ethyl ketone, MEK), methyl iso-butyl ketone, acetone, methanol, ethanol, 2-propanol, ethyl acetate, propyl acetate, butyl acetate, ethyl lactate, tetrahydrofuran, or mixtures thereof. An aqueous-based coating formulation for the transparent silver nanowire films can be prepared by mixing the various components with one or more polymer binders in water or in a mixture of water with a water miscible solvent such as acetone, acetonitrile, methanol, ethanol, 2-propanol, or tetrahydrofuran, or mixtures thereof. Transparent films containing silver nanowires can be prepared by coating the formulations using various coating procedures such as wire wound rod coating, dip coating, knife or blade coating, curtain coating, slide coating, slot-die coating, roll coating, or gravure coating. Surfactants and other coating aids can be incorporated into the coating formulation.

In one embodiment the coating weight of the silver nanowires is from about 10 mg/m² to about 500 mg/m². In another embodiment the coating weight of silver nanowires is from about 20 mg/m² to about 200 mg/m². In a further embodiment, the coating weight of silver nanowires is from about 30 mg/m² to about 120 mg/m². A useful coating dry thickness of the transparent conductive coating is from about 0.05 μm to about 2.0 μm, and preferably from about 0.1 μm to about 0.5 μm.

Upon coating and drying, the transparent conductive film should have a surface resistivity of less than 1,000 ohms/sq and preferably less than 500 ohm/sq.

Upon coating, and drying, the transparent conductive film should have as high a % transmittance as possible. A transmittance of at least 70% is useful. A transmittance of at least 80% and even at least 90% are even more useful.

Particularly useful are films with a transmittance of at least 70% and a surface resistivity of less than 500 ohm/sq.

Such transparent conductive films provide transmittance of at least 80% across entire spectrum range of from about 350 nm to about 1100 nm, and surface resistivity of less than 500 ohm/sq.

### Transparent Support

In one embodiment, the conductive materials are coated onto a support. The support may be rigid or flexible.

Suitable rigid substrates include, for example, glass, polycarbonates, acrylics, and the like.

When the conductive materials are coated onto a flexible support, the support is preferably a flexible, transparent polymeric film that has any desired thickness and is composed of one or more polymeric materials. The support is required to exhibit dimensional stability during coating and drying of the conductive layer and to have suitable adhesive properties with overlying layers. Useful polymeric materials for making such supports include polyesters [such as poly(ethylene terephthalate) (PET) and poly(ethylene naphthalate) (PEN)], cellulose acetates and other cellulose esters, polyvinyl acetal, polyolefins, polycarbonates, and polystyrenes. Preferred supports are composed of polymers having good heat stability, such as polyesters and polycarbonates. Support materials may also be treated or annealed to reduce shrinkage and promote dimensional stability. Transparent multilayer supports can also be used.

Coating of the Conductive Films onto a Support

Transparent conductive articles can be prepared by coating the formulations described above onto a transparent support using various coating procedures such as wire wound rod coating, dip coating, knife coating, curtain coating, slide coating, slot-die coating, roll coating, gravure coating, or extrusion coating.

Alternatively, transparent conductive articles can be prepared by laminating the transparent conductive films prepared as described above onto a transparent support.

In some embodiments, a “carrier” layer formulation comprising a single-phase mixture of two or more polymers may be applied directly onto the support and thereby located between the support and the silver nanowire layer. The carrier layer serves to promote adhesion of the support to the transparent polymer layer containing the silver nanowires. The carrier layer formulation can be sequentially or simultaneously applied with application of the transparent conductive silver nanowire layer formulation. It is preferred that all coating be applied simultaneously onto the support. Carrier layers are often referred to as “adhesion promoting layers,” “interlayers,” or “intermediate layers.”

As noted above, in one embodiment the coating weight of the silver nanowires is from about 20 mg/m² to about 500 mg/m². In other embodiments, coating weight of silver nanowires is from about 10 mg/m² to about 200 mg/m². Embodiments wherein the silver nanowires are coated at from about 10 mg/m² to about 120 mg/m² are also contemplated.

Upon coating and drying, the transparent conductive article should have a surface resistivity of less than 1,000 ohms/sq and preferably less than 500 ohm/sq.

Similarly, upon coating and drying on a transparent support, the transparent conductive article should have as high an optical transmittance as possible. A transmittance of at least 70% is useful. A transmittance of at least 80% and even at least 90% are even more useful.

Particularly preferred are articles with a transmittance of at least 80% and a surface resistivity of less than 500 ohm/sq.

### EXEMPLARY EMBODIMENTS

U.S. Provisional Application No. 61/736,563, filed Dec. 13, 2012, entitled ANTICORROSION AGENTS FOR TRANSPARENT CONDUCTIVE FILM, which is hereby incorporated by reference in its entirety, disclosed the following 30 non-limiting, exemplary embodiments:

A. A transparent conductive article comprising:

a transparent support;

at least one first layer disposed on the transparent support, the at least one first layer comprising a network of silver nanowires dispersed within at least one polymer binder; and

at least one second layer disposed on the at least one first layer, the at least one second layer comprising one or more anticorrosion agents comprising at least one mercaptotetrazole or mercaptotriazole.

B. The transparent conductive article according to embodiment A, wherein the at least one mercaptotetrazole comprises at least one compound having the general structure (I):

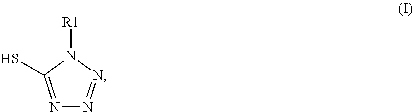

wherein R1 is one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, an amino group (NR₂R₃) where R₂ and R₃ are independently a hydrogen, an alkyl group comprising up to 20 carbon atoms, or an aryl group comprising up to 10 carbon atoms, a thioether group (SR₄) where R₄ is an alkyl group comprising up to 20 carbon atoms, or an aryl group comprising up to 10 carbon atoms, a sulfoxy group (SOR₄), a sulfone group (SO₂R₄), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₂R₃), an acylamino group (NR₂COR₄), an acyl group (COR₄), an acyloxy group (OCOR₄), or a sulfonamido group (SO₂NR₂R₃).
C. The transparent conductive article according to embodiment A, wherein the at least one mercaptotetrazole comprises 1-phenyl-1H-tetrazole-5-thiol.
D. The transparent conductive article according to embodiment A, wherein the at least one mercaptotetrazole comprises at least one compound having the structure (II):

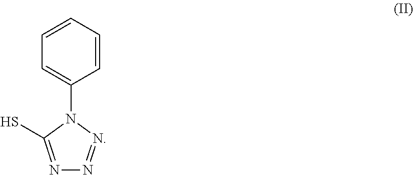 [SMILES: Sc1nnnn1-c1ccccc1]

E. The transparent conductive article according to embodiment A, wherein the at least one mercaptotriazole comprises at least one 1,2,4-mercaptotriazole.
F. The transparent conductive article according to embodiment A, wherein the at least one mercaptotriazole comprises at least one compound having the general structure (III):

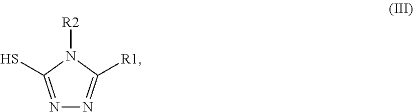

wherein R1 and R2 are independently one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, an amino group (NR₃R₄) where R₃ and R₄ are independently a hydrogen, an alkyl group comprising up to 20 carbon atoms, or an aryl group comprising up to 10 carbon atoms, a thioether group (SR₅) where R₅ is an alkyl group comprising up to 20 carbon atoms, or an aryl group comprising up to 10 carbon atoms, a sulfoxy group (SOR₅), a sulfone group (SO₂R₅), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₃R₄), an acylamino group (NR₄COR₅), an acyl group (COR₅), an acyloxy group (OCOR₅), or a sulfonamido group (SO₂NR₃R₄).
G. The transparent conductive article according to embodiment A, wherein the at least one mercaptotriazole comprises 4-benzyl-1,2,4-triazole-3-thiol.
H. The transparent conductive article according to embodiment A, wherein the at least one mercaptotriazole comprises at least one compound having the structure (IV):

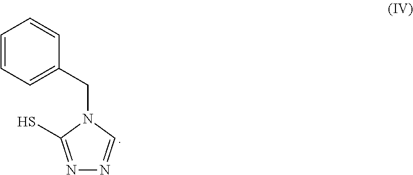 [SMILES: Sc1nncn1Cc1ccccc1]

J. The transparent conductive article according to embodiment A, wherein the at least one mercaptotriazole comprises 4-benzyl-5-hydroxymethyl-1,2,4-triazole-3-thiol.
K. The transparent conductive article according to embodiment A, wherein the at least one mercaptotriazole comprises at least one compound having the structure (V):

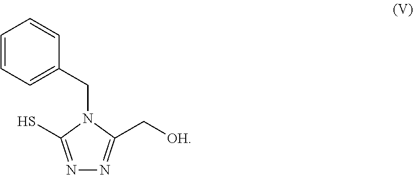 [SMILES: OCc1nnc(S)n1Cc1ccccc1]

L. The transparent conductive article of embodiment A, wherein the silver nanowires are present in an amount sufficient to provide a surface resistivity of less than 1000 ohm/sq.
M. The transparent conductive article of embodiment A, wherein the silver nanowires have an aspect ratio of from about 20 to about 3300.
N. The transparent conductive article of embodiment A, wherein the silver nanowires are present in an amount of from about 10 mg/m² to about 500 mg/m².
P. The transparent conductive article of embodiment A, having a transmittance of at least 80% across entire spectrum range of from about 350 nm to about 1100 nm and a surface resistivity of 500 ohm/sq or less.
Q. The transparent conductive article of embodiment A, wherein the at least one polymer binder comprises at least one water soluble polymer.
R. The transparent conductive article of embodiment Q, wherein the at least one water soluble polymer comprises gelatin, polyvinyl alcohol, or mixtures thereof.
S. The transparent conductive article of embodiment R, wherein the at least one polymer binder further comprises up to 50 wt % of one or more additional water soluble polymers.
T. The transparent conductive article of embodiment S, wherein one or more of the additional water soluble polymers is a polyacrylic polymer.
U. The transparent conductive article of embodiment A, wherein the at least one polymer binder comprises at least one organic solvent soluble polymer.
V. The transparent conductive article of embodiment U, wherein the at least one organic solvent soluble polymer binder comprises at least one cellulose ester polymer.
W. The transparent conductive article of embodiment U, wherein the at least one organic solvent soluble polymer binder comprises cellulose acetate, cellulose acetate butyrate, or cellulose acetate propionate, or mixtures thereof.
X. The transparent conductive article of embodiment V, wherein the at least one cellulose ester polymer has a glass transition temperature of at least 100° C.
Y. The transparent conductive article of embodiment U, wherein the at least one polymer binder further comprises up to 50 wt % of one or more additional organic solvent soluble polymers.
Z. The transparent conductive article of embodiment Y, wherein the one or more of the additional organic solvent soluble polymers is a polyester polymer.
AA. A method comprising:

applying at least one first coating mixture onto a transparent support to form at least one first coated layer, the at least one first coating mixture comprising silver nanowires and at least one polymer binder; and

applying at least one second coating mixture onto the at least one first coated layer to form at least one second coated layer, the at least one second coating mixture comprising at least one mercaptotetrazole or mercaptotriazole.

AB. The method according to embodiment AA, wherein the applying the at least one first coating mixture and the applying the at least one second coating mixture occur simultaneously.
AC. The method according to embodiment AA, further comprising drying the at least one first layer or the at least one second layer or both.
AD. A method comprising:

applying at least one first coating mixture onto a transparent support to form at least one first coated layer, the at least one first coating mixture comprising at least one mercaptotetrazole or mercaptotriazole; and

applying at least one second coating mixture onto the at least one first coated layer to form at least one second coated layer, the at least one second coating mixture comprising silver nanowires and at least one polymer binder.

AE. The method according to embodiment AD, wherein the applying the at least one first coating mixture and the applying the at least one second coating mixture occur simultaneously.
AF. The method according to embodiment AD, further comprising drying the at least one first layer or the at least one second layer or both.

### EXAMPLES

### Materials

All materials used in the following examples are readily available from standard commercial sources, such as Aldrich Chemical Co. (Milwaukee, Wis.) unless otherwise specified. All percentages are by weight unless otherwise indicated. The following additional methods and materials were used.

BHTT is 4-benzyl-1,2,4-triazole-3-thiol. Its structure is shown below.

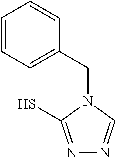 [SMILES: Sc1nncn1Cc1ccccc1]

BZTT is 4-benzyl-5-hydroxymethyl-1,2,4-triazole-3-thiol. Its structure is shown below:

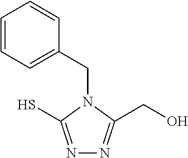 [SMILES: OCc1nnc(S)n1Cc1ccccc1]

CAB 381-20 is a cellulose acetate butyrate resin available from Eastman Chemical Co. (Kingsport, Tenn.). It has a glass transition temperature of 14° C.

CAB 553-0.4 is a cellulose acetate butyrate resin available from Eastman Chemical Co. (Kingsport, Tenn.). It has a glass transition temperature of 136° C.

PMT is 1-phenyl-1H-tetrazole-5-thiol. Its structure is shown below:

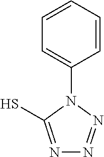 [SMILES: Sc1nnnn1-c1ccccc1]

Silver nanowires were prepared according to the methods of U.S. provisional patent application No. 61/723,942, filed Nov. 8, 2012, entitled “NANOWIRE PREPARATION METHODS, COMPOSITIONS, AND ARTICLES,” which is hereby incorporated by reference in its entirety. Silver nanowires so prepared exhibited diameters ranging from 38 to 44 nm, and length ranging from 17 to 25 μm.

### Methods

Transparent conductive films were evaluated using two protocols: the 80° C. Stability Test, the 150° C. Stability Test, and the Desktop Stability Test.

In the 80° C. Stability Test, surface resistivity was measured immediately after coating using either an RCHEK model RC2175 Surface Resistivity meter, available from Electronic Design To Market, Inc. (Toledo, Ohio), or a DELCOM 707 non-contact conductance monitor, available from Delcom Instruments, Inc. (Minneapolis, Minn.). The films were then placed in a BLUE-M oven with free air flow at 80° C. for either five or ten days, after which the surface resistivity was again measured. The difference between the final and initial surface resistivities was recorded.

In the 150° C. Stability Test, surface resistivity was measured immediately after coating using either an RCHEK model RC2175 Surface Resistivity meter, available from Electronic Design To Market, Inc. (Toledo, Ohio), or a DELCOM 707 non-contact conductance monitor, available from Delcom Instruments, Inc. (Minneapolis, Minn.). The films were then placed in a BLUE-M oven with free air flow at 150° C. for either 30 min or 120 min, after which the surface resistivity was again measured. The difference between the final and initial surface resistivities was recorded.

In the Desktop Stability Test, surface resistivity was measured immediately after coating using either an RCHEK RC2175 four point resistivity meter or a DELCOM 707 non-contact conductance monitor. The films were then placed under 1500-2000 lux fluorescent lights, coated side up, for 0.5, 1, or 2 months, after which the surface resistivity was again measured. The difference between the final and initial surface resistivities was recorded.

### Example 1

### Preparation of Silver Nanowire Coated Substrates

A CAB polymer premix solution was prepared by mixing 15 parts by weight of CAB 381-20 (cellulose acetate butyrate polymer, Eastman Chemical) with 85 parts by weight of n-propyl acetate (Oxea). The resulting CAB polymer premix solution was filtered prior to use.

15.00 parts by weight of the CAB polymer premix solution was combined with 10.00 parts by weight ethyl lactate (>99.8% purity), 40.55 parts by weight of a 1.85% solids dispersion of silver nanowires in isopropanol, and 34.44 parts by weight of n-propyl acetate (Oxea) to form a silver nanowire coating dispersion of 3.00% solids.

The finished silver nanowire dispersion was coated onto a 5 mil polyester support using a lab proofer with a 380 line per inch plate, and then dried at 235° F. for 2 min.

### Preparation of Topcoat Solutions (CAB)

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 5000 parts by weight of the CAB polymer premix solution, 2485 parts by weight denatured ethanol, 4500 parts by weight of 33 wt % CYMEL 303 (hexamethoxymethylmelamine, Cytec) in denatured ethanol, 158 parts by weight of 15 wt % SLIP-AYD FS-444 (polysiloxane in dipropylene glycol ether, Elementis) in denatured ethanol, 188 parts by weight of 20 wt % p-toluene sulfonic acid (Fisher/Univar) in denatured ethanol, and 1374 parts by weight of n-butanol (>98% purity). The topcoat masterbatch solution had 16.78 wt % solids.

Finished topcoat solutions were prepared by adding various loadings of PMT, BHTT, and BZTT to aliquots of the masterbatch solution, as shown in Table I. The finished topcoat solutions were then coated onto silver nanowire coated substrates using a lab proofer with a 450 line per inch plate, and then dried at 255° F. for 3 min. The resulting samples were designated 1-1, 1-2, and 1-3.

### Preparation of Topcoat Solutions (Acrylic Polyol)

An acrylic polyol premix solution was prepared by mixing 20 parts by weight of AROLON 6433 acrylic polyol resin (Reichold Chemical) into 80 parts by weight of denatured ethanol. The resulting acrylic polyol premix solution was filtered prior to use.

A topcoat masterbatch solution was prepared by adding to 5000 parts by weight of the acrylic polyol premix solution: 2485 parts by weight denatured ethanol, 4500 parts by weight of 33 wt % CYMEL 303 (hexamethoxymethylmelamine, Cytec) in denatured ethanol, 158 parts by weight of 15 wt % SLIP-AYD FS-444 (polysiloxane in dipropylene glycol ether, Elementis) in denatured ethanol, 188 parts by weight of 20 wt % p-toluene sulfonic acid (Fisher/Univar) in denatured ethanol, and 1374 parts by weight of n-butanol (>98% purity). The topcoat masterbatch solution had 16.8 wt % solids.

Finished topcoat solutions were prepared by adding various loadings of PMT, BHTT, and BZTT to aliquots of the masterbatch solution, as shown in Table I. The finished topcoat solutions were then coated onto silver nanowire coated substrates using a lab proofer with a 450 line per inch plate, and then dried at 255° F. for 3 min. The resulting samples were designated 1-4, 1-5, and 1-6.

### Evaluation of Coatings

The transparent conductive films comprising CAB-based topcoats and acrylic polyol-based topcoats were evaluated using the 80° C. stability test and the desktop stability test. The results are shown in Table II. The coatings comprising PMT, BHTT, or BZTT showed improved results relative to the stabilizer-free comparative samples Com-1-1 and Com-1-2.

TABLE I

| | | | Stabilizer | | |
|---|---|---|---|---|---|
| | | | Loading | | Total |
| | | | (wt % in | Initial | Light |
| Sample | | | topcoat | Resistance | Transmittance |
| ID | Polyol | Stabilizer | solution) | (ohms/sq) | (percent) |
| Com-1-1 | CAB | None | 0.000 | 66 | 87.5 |
| 1-1 | CAB | PMT | 0.168 | 85 | 88.1 |
| 1-2 | CAB | BHTT | 0.168 | 71 | 87.4 |
| 1-3 | CAB | BZTT | 0.168 | 85 | 87.7 |
| Com-1-2 | Acrylic | None | 0.000 | 60 | 87.5 |
| 1-4 | Acrylic | PMT | 0.168 | 84 | 89.2 |
| 1-5 | Acrylic | BHTT | 0.168 | 120 | 89.2 |
| 1-6 | Acrylic | BZTT | 0.168 | 89 | 89.4 |

TABLE II

Change in Resistance (ohms/sq)

| | 80° C. at | Desktop at | Desktop at | Desktop at |
|---|---|---|---|---|
| Sample ID | 5 days | 2 wks | 1 mo | 2 mos |
| Com-1-1 | +Infinite | +57% | +76% | +111% |
| 1-1 | +19% | +5% | +3% | 0 |
| 1-2 | +23% | +3% | +9% | +26% |
| 1-3 | +1612% | +1% | 0 | +24% |
| Com-1-2 | +81% | +4% | +10% | +100% |
| 1-4 | +22% | −4% | −4% | +10% |
| 1-5 | +20% | −3% | 0 | +25% |
| 1-6 | −4% | +2% | −2% | +14% |

### Example 2

### Preparation of Silver Nanowire Coated Substrates

Silver nanowire coated substrates were prepared according to the procedure of Example 1.

### Preparation of Topcoat Solutions (CAB)

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 5000 parts by weight of the CAB polymer premix solution: 12076 parts by weight denatured ethanol, 10188 parts by weight of 33 wt % SR399 (dipentaerythritolpentaacrylate, Sartomer) in denatured ethanol, 660 parts by weight of 10 wt % SLIP-AYD FS-444 (polysiloxane in dipropylene glycol ether, Elementis) in denatured ethanol, 1509 parts by weight of 10 wt % X-CURE 184 (Dalian) in denatured ethanol, and 1132 parts by weight of n-butanol (>98% purity). The topcoat masterbatch solution had 14.1 wt % solids.

Finished topcoat solutions were prepared by adding various loadings of PMT, BHTT, and BZTT to aliquots of the masterbatch solution, as shown in Table III. The finished topcoat solutions were then coated onto silver nanowire coated substrates using a lab proofer with a 450 line per inch plate, and then dried in an oven at 220° F. for 3 min. The dried TCFs were then UV-cured via two-pass processing under a FUSION 300 UV-H lamp at 20 feet/minute. The resulting samples were designated 2-1, 2-2, 2-3, 2-4, 2-5, and 2-6.

### Preparation of Topcoat Solutions (Acrylic Polyol)

An acrylic polyol premix solution was prepared by mixing 20 parts by weight of AROLON 6433 acrylic polyol resin (Reichold Chemical) into 80 parts by weight of denatured ethanol. The resulting acrylic polyol premix solution was filtered prior to use.

A topcoat masterbatch solution was prepared by adding to 5000 parts by weight of the acrylic polyol premix solution: 12076 parts by weight denatured ethanol, 10188 parts by weight of 33 wt % SR399 (dipentaerythritolpentaacrylate, Sartomer) in denatured ethanol, 660 parts by weight of 10 wt % SLIP-AYD FS-444 (polysiloxane in dipropylene glycol ether, Elementis) in denatured ethanol, 1509 parts by weight of 10 wt % X-CURE 184 (Dalian) in denatured ethanol, and 1132 parts by weight of n-butanol (>98% purity). The topcoat masterbatch solution had 14.1 wt % solids.

Finished topcoat solutions were prepared by adding various loadings of PMT, BHTT, and BZTT to aliquots of the masterbatch solution, as shown in Table III. The finished topcoat solutions were then coated onto silver nanowire coated substrates using a lab proofer with a 450 line per inch plate, and then dried at 220° F. for 2 min. The dried TCFs were then UV-cured via two-pass processing under a FUSION 300 UV-H lamp at 20 feet/minute. The resulting samples were designated 2-7, 2-8, 2-9, 2-10, 2-11, and 2-12.

### Evaluation of Coatings

The transparent conductive films comprising CAB-based topcoats and acrylic polyol-based topcoats were evaluated using the 80° C. stability test and the desktop stability test. The results are shown in Table IV. The coatings comprising PMT, BHTT, or BZTT showed improved results relative to the stabilizer-free comparative samples Com-2-1 and Com-2-2.

TABLE III

| | | | Stabilizer | | |
|---|---|---|---|---|---|
| | | | Loading | | Total |
| | | | (wt % in | Initial | Light |
| Sample | | | topcoat | Resistance | Transmittance |
| ID | Polyol | Stabilizer | solution) | (ohms/sq) | (percent) |
| Com-2-1 | CAB | None | 0.000 | 76 | 88.4 |
| 2-1 | CAB | PMT | 0.120 | 80 | 89.2 |
| 2-2 | CAB | PMT | 0.235 | 72 | 89.2 |
| 2-3 | CAB | BHTT | 0.120 | 91 | 89.2 |
| 2-4 | CAB | BHTT | 0.235 | 81 | 89.3 |
| 2-5 | CAB | BZTT | 0.120 | 99 | 89.1 |
| 2-6 | CAB | BZTT | 0.235 | 96 | 89.3 |
| Com-2-2 | Acrylic | None | 0.000 | 98 | 88.3 |
| 2-7 | Acrylic | PMT | 0.120 | 74 | 89.7 |
| 2-8 | Acrylic | PMT | 0.235 | 100 | 89.5 |
| 2-9 | Acrylic | BHTT | 0.120 | 115 | 89.9 |
| 2-10 | Acrylic | BHTT | 0.235 | 77 | 89.5 |
| 2-11 | Acrylic | BZTT | 0.120 | 110 | 89.6 |
| 2-12 | Acrylic | BZTT | 0.235 | 75 | 89.5 |

TABLE IV

Percent Change in Resistance

| | 80° C. at | Desktop at | Desktop at | Desktop at |
|---|---|---|---|---|
| Sample ID | 10 days | 2 wks | 1 mo | 2 mos |
| Com-2-1 | +7358% | +11 | +30% | +77% |
| 2-1 | +22% | −2% | −2% | +22% |
| 2-2 | +29% | −6% | −1% | +13% |
| 2-3 | +15% | −10% | −10% | 0 |
| 2-4 | +26% | −4% | +1% | +12% |
| 2-5 | +31% | −2% | 0 | +14% |
| 2-6 | +36% | −4% | +1% | +17% |
| Com-2-1 | +1695% | +16% | +70% | +601% |
| 2-7 | +37% | −3% | +1% | +25% |
| 2-8 | +21% | −5% | 0 | +8% |
| 2-9 | +45% | −15% | −9% | 0 |
| 2-10 | +40% | 0 | +19% | +23% |
| 2-11 | +72% | +3% | +8% | +36% |
| 2-12 | +12% | −4% | +13% | +36% |

### Example 3

### Preparation of Silver Nanowire Coated Substrates

Silver nanowire coated substrates were prepared according to the procedure of Example 1.

### Preparation of Topcoat Solutions (Thermally Cured)

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 5000 parts by weight of the CAB polymer premix solution: 3469 parts by weight denatured ethanol, 4500 parts by weight of 33 wt % CYMEL 303 (hexamethoxymethylmelamine, Cytec) in denatured ethanol, 150 parts by weight of 10 wt % SLIP-AYD FS-444 (polysiloxane in dipropylene glycol ether, Elementis) in denatured ethanol, 1125 parts by weight of 20 wt % maleic acid (Univar) in denatured alcohol, and 250 parts by weight of 20 wt % p-toluene sulfonic acid (Fisher/Univar) in denatured ethanol. The topcoat masterbatch solution had 17.0 wt % solids.

Finished topcoat solutions were prepared by adding various loadings of PMT to aliquots of the masterbatch solution, as shown in Table V. The finished topcoat solutions were then coated onto silver nanowire coated substrates with a 450 line per inch plate, and then dried at 275° F. for 3 min. The resulting sample was designated 3-1.

### Preparation of Topcoat Solutions (UV Cured)

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 5000 parts by weight of the CAB polymer premix solution: 7474 parts by weight denatured ethanol, 4500 parts by weight of 50 wt % SR399 (dipentaerythritolpentaacrylate, Sartomer) in denatured ethanol, 168 parts by weight of 19 wt % SLIP-AYD FS-444 (polysiloxane in dipropylene glycol ether, Elementis) in denatured ethanol, and 1000 parts by weight of 25 wt % X-CURE 184 (Dalian) in denatured ethanol. The topcoat masterbatch solution had 18.0 wt % solids.

Finished topcoat solutions were prepared by adding various loadings of PMT, BHTT, and BZTT to aliquots of the masterbatch solution, as shown in Table V. The finished topcoat solutions were then coated onto silver nanowire coated substrates using a lab proofer with a 450 line per inch plate, and then dried in an oven at 110° F. for 3 min. The dried TCFs were then UV-cured via two-pass processing under a FUSION 300 UV-H lamp at 20 feet/minute. The resulting sample was designated 3-2.

### Evaluation of Coated Samples

Surface resistivity was measured immediately after coating using either an RCHEK model RC2175 Surface Resistivity meter, available from Electronic Design To Market, Inc. (Toledo, Ohio), or a DELCOM 707 non-contact conductance monitor, available from Delcom Instruments, Inc. (Minneapolis, Minn.). The films were then placed in a BLUE-M oven with free air flow at 150° C. for 30 min, after which the surface resistivity was again measured. The samples were returned to the oven to provide an additional 90 min exposure to 150 C air, after which resistivities were again measured. The results, shown in Table V, show that samples comprising PMT exhibited improved annealing performance relative to samples without PMT (Com-3-1 and Com-3-2).

TABLE V

| | | | | Resistance | Resistance |
|---|---|---|---|---|---|
| | | PMT in | | after | after |
| | Type of | Topcoat | Initial | 30 min at | 120 min at |
| | Topcoat | Solution | Resistance | 150° C. | 150° C. |
| Sample ID | Cure | (wt %) | (ohms/sq) | (ohms/sq) | (ohms/sq) |
| Com-3-1 | Thermal | 0 | 65 | 0 | +20% |
| 3-1 | Thermal | 0.180 | 74 | 0 | +4% |
| Com-3-2 | UV | 0 | 85 | +16% | +25% |
| 3-2 | UV | 0.149 | 70 | −2% | +3% |

### Example 4

### Preparation of Silver Nanowire Coated Substrates

Silver nanowire coated substrates were prepared according to the procedure of Example 1.

### Preparation of Topcoat Solutions

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 5000 parts by weight of the CAB polymer premix solution, 10080 parts by weight denatured ethanol, 4500 parts by weight of 33 wt % CYMEL 303 (hexamethoxymethylmelamine, Cytec) in denatured ethanol, 150 parts by weight of 10 wt % SLIP-AYD FS-444 (polysiloxane in dipropylene glycol ether, Elementis) in denatured ethanol, 1125 parts by weight of 20 wt % maleic acid (Univar) in denatured alcohol, and 250 parts by weight of 20 wt % p-toluene sulfonic acid (Fisher/Univar) in denatured ethanol. The topcoat masterbatch solution had 12.0 wt % solids.

Finished topcoat solutions were prepared by adding various loadings of PMT to aliquots of the masterbatch solution, as shown in Table VI. The finished topcoat solutions were then coated onto silver nanowire coated substrates using a lab proofer with a 450 line per inch plate, and then dried at 255° F. for 3 min. The resulting samples were designated 4-1, 4-2, and 4-3.

### Evaluation of Films

The coated films were evaluated using the 80° C. stability test and the desktop stability test. The results, shown in Table VII show that samples comprising PMT exhibited improved performance relative to the sample without PMT (Com-4-1).

TABLE VI

| | PMT in | | Total | |
|---|---|---|---|---|
| | Topcoat | Initial | Light | |
| | Solution | Resistance | Transmittance | |
| Sample ID | (wt %) | (ohms/sq) | (percent) | % Haze |
| Com-4-1 | 0 | 51 | 89.6 | 1.96 |
| 4-1 | 0.071 | 52 | 89.7 | 1.93 |
| 4-2 | 0.143 | 52 | 89.7 | 1.93 |
| 4-3 | 0.214 | 53 | 89.7 | 1.95 |

TABLE VII

| | Percent Change in Resistance | | |
|---|---|---|---|
| Sample ID | 80° C. at 12 days | Desktop at 1 mo | Desktop at 2 mos |
| Com-4-1 | +57 | +42 | +79 |
| 4-1 | +39 | +11 | +11 |
| 4-2 | +43 | +4 | +11 |
| 4-3 | +30 | −4 | −2 |

### Example 5

### Preparation of Silver Nanowire Coated Substrates

A CAB polymer premix solution was prepared by mixing 15 parts by weight of CAB 381-20 (cellulose acetate butyrate polymer, Eastman Chemical) with 85 parts by weight of n-propyl acetate (Oxea). The resulting CAB polymer premix solution was filtered prior to use. 5.15 parts by weight of the CAB polymer premix solution was combined with 5.75 parts by weight ethyl lactate (>99.8% purity), 10.44 parts by weight of a 1.85% solids dispersion of silver nanowires in isopropanol, and 36.41 parts by weight of n-propyl acetate (Oxea) to form a silver nanowire coating dispersion at 0.97% solids.

The finished silver nanowire coating dispersion was coated on a slot die coater onto XST polyester support (Dupont Teijin), and dried at 250° F. for 2 min.

### Preparation of Topcoat Solutions

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 1000 parts by weight of the CAB polymer premix solution, 285 parts by weight denatured ethanol, 900 parts by weight of 50 wt % SR399 (dipentaerythritolpentaacrylate, Sartomer) in denatured ethanol, 30 parts by weight of 10 wt % SLIP-AYD FS-444 (polysiloxane in dipropylene glycol ether, Elementis) in denatured ethanol, 900 parts by weight of 5 wt % IRGACURE 369 (Ciba) in n-propyl acetate (Oxea) and 320 parts by weight of n-butanol (>98% purity). The topcoat masterbatch solution had 18.82% solids.

Finished topcoat solutions were prepared by adding various loadings of PMT to aliquots of the masterbatch solution, as shown in Table VIII. The finished topcoat solutions were then coated onto silver nanowire coated substrates using a lab proofer with a 450 line per inch plate, and then dried at 120° F. for 2 min, followed by two pass UV curing with a FUSION 300 UV-H lamp at 30 ft/min linear speed. The resulting samples were designated 5-1, 5-2, 5-5, and 5-4.

### Evaluation of Films

The coated films were evaluated using the 80° C. stability test and the desktop stability test. The results, shown in Table VIII show that samples comprising PMT exhibited improved performance relative to the sample without PMT (Com-5-1).

### Example 6

### Preparation of Silver Nanowire Coated Substrates

Silver nanowire coated substrates were prepared according to the procedure of Example 5.

### Preparation of Topcoat Solutions

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A topcoat masterbatch solution was prepared by adding to 1000 parts by weight of the CAB polymer premix solution, 900 parts by weight of 50 wt % SR399 (dipentaerythritolpentaacrylate, Sartomer) in denatured ethanol, 30 parts by weight of 10 wt % SLIP-AYD FS-444 (polysiloxane in dipropylene glycol ether, Elementis) in denatured ethanol, 1025 parts by weight of 5 wt % IRGACURE 369 (Ciba) in n-propyl acetate (Oxea), and 320 parts by weight of n-butanol (>98% purity). The topcoat masterbatch solution had 19.9% solids.

Finished topcoat solutions were prepared by adding various loadings of PMT to aliquots of the masterbatch solution, as shown in Table IX. The finished topcoat solutions were then coated onto silver nanowire coated substrates using a lab proofer with a 450 line per inch plate, and then dried at 120° F. for 2 min, followed by two pass UV curing with a FUSION 300 UV-H lamp at 30 ft/min linear speed. The resulting samples were designated 6-1, 6-2, and 6-3.

TABLE VIII

| | | | Surface | Surface | Surface | Surface | Surface | Surface | Surface |
|---|---|---|---|---|---|---|---|---|---|
| | | Initial | Resistivity | Resistivity | Resistivity | Resistivity | Resistivity | Resistivity | Resistivity |
| | PMT in | Surface | Change | Change | Change | Change | Change | Change | Change |
| | Topcoat | Resistivity | 80° C. | Desktop | Desktop | Desktop | Desktop | Desktop | Desktop |
| | Solution | t = 0 | t = 10 day | t = 1 mos. | t = 2 mos. | t = 3 mos. | t = 4 mos. | t = 5 mos. | t = 6 mos. |
| Sample | (wt %) | (ohms/sq) | (% change) | (% change) | (% change) | (% change) | (% change) | (% change) | (% change) |
| Com-5-1 | 0 | 72 | +21 | +36 | +81 | +593 | ∞ | ∞ | ∞ |
| 5-1 | 0.14 | 82 | +16 | +1 | +2 | +2 | +6 | +16 | +27 |
| 5-2 | 0.14 | 76 | +6 | +2 | +8 | +9 | +10 | +17 | +22 |
| 5-3 | 0.28 | 86 | +8 | +3 | +3 | +6 | +9 | +17 | +26 |
| 5-4 | 0.28 | 80 | +1 | +1 | +2 | +5 | +15 | +14 | +19 |

TABLE IX

| | | | Surface | Surface | Surface | Surface | Surface | Surface | Surface |
|---|---|---|---|---|---|---|---|---|---|
| | | Initial | Resistivity | Resistivity | Resistivity | Resistivity | Resistivity | Resistivity | Resistivity |
| | PMT in | Surface | Change | Change | Change | Change | Change | Change | Change |
| | Topcoat | Resistivity | 80° C. | Desktop | Desktop | Desktop | Desktop | Desktop | Desktop |
| | Solution | t = 0 | t = 10 day | t = 1 mos. | t = 2 mos. | t = 3 mos. | t = 4 mos. | t = 5 mos. | t = 6 mos. |
| Sample | (wt %) | (ohms/sq) | (% change) | (% change) | (% change) | (% change) | (% change) | (% change) | (% change) |
| Com-6-1 | 0 | 72 | +62 | +18 | +67 | +342 | ∞ | ∞ | ∞ |
| 6-1 | 0.14 | 83 | +8 | +11 | +26 | 24 | +18 | +18 | +16 |
| 6-2 | 0.28 | 79 | +8 | +3 | +4 | +4 | +15 | +20 | +23 |
| 6-3 | 0.43 | 79 | +12 | +3 | +3 | +4 | +20 | +21 | +28 |

### Evaluation of Films

The coated films were evaluated using the 80° C. stability test and the desktop stability test. The results, shown in Table IX show that samples comprising PMT exhibited improved performance relative to the sample without PMT (Com-6-1).

### Example 7

### Preparation of Silver Nanowire Coated Substrates

A CAB polymer premix solution was prepared by mixing 15 parts by weight of CAB 381-20 (cellulose acetate butyrate polymer, Eastman Chemical) with 85 parts by weight of n-propyl acetate (Oxea). The resulting CAB polymer premix solution was filtered prior to use.

4.35 parts by weight of the CAB polymer premix solution was combined with 2.90 parts by weight ethyl lactate (>99.8% purity), 11.76 parts by weight of a 1.85% solids dispersion of silver nanowires in isopropanol, and
9.99 parts by weight of n-propyl acetate (Oxea) to form a silver nanowire coating dispersion at 3.00% solids.

The finished silver nanowire coating dispersion was coated on a slot die coater onto XST polyester support (Dupont Teijin), and dried at 250° F.

### Preparation of Topcoat Solutions

A CAB polymer premix solution was prepared by mixing 15 parts by weight of CAB 553-0.4 (cellulose acetate butyrate polymer, Eastman Chemical) into 42.50 parts by weight of denatured ethanol and 42.50 parts by weight methanol (>99% purity). The resulting CAB polymer premix solution was filtered prior to use.

A control topcoat solution was prepared by adding 5512 parts by weight of the CAB polymer premix solution to 8239 parts by weight of denatured ethanol, 4961 parts by weight of 50 wt % SR399 (dipentaerythritolpentaacrylate, Sartomer) in denatured ethanol, 185 parts by weight of 20 wt % SLIP-AYD FS-444 (polysiloxane in dipropylene glycol ether, Elementis) in denatured ethanol, and 1102 parts by weight of 25 wt % XCURE 184 (Dalian) in methanol. The control topcoat solution had 18.1% solids.

A masterbatch topcoat solution was prepared by adding to 5510 parts by weight of the CAB polymer premix solution to 5260 parts by weight of denatured ethanol, 4959 parts by weight of 50 wt % SR399 (dipentaerythritolpentaacrylate, Sartomer) in denatured ethanol, 180 parts by weight of 20 wt % SLIP-AYD FS-444 (polysiloxane in dipropylene glycol ether, Elementis) in denatured ethanol, and 1102 parts by weight of 25 wt % XCURE 184 (Dalian) in methanol. The masterbatch solution had 18.2% solids.

Finished topcoat solutions were prepared by adding various loadings of PMT to aliquots of the masterbatch solution, as shown in Tables X and XI. The finished topcoat solutions were then coated onto silver nanowire coated substrates using a gravure coater, and then dried at 110° F., followed by UV curing with a FUSION 300 UV-H lamp at 100 ft/min linear speed. The resulting samples were designated 7-1, 7-2, 7-3, and 7-3.

### Evaluation of Films

The coated films were evaluated using the 150° C. stability test and the desktop stability test. The results, shown in Tables X and XI show that samples comprising PMT exhibited improved performance relative to the samples without PMT (Com-7-1 and Com-7-2).

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

TABLE X

| | | | Surface | Surface |
|---|---|---|---|---|
| | | Initial | Resistivity | Resistivity |
| | | Surface | Change | Change |
| | | Resistivity | 150° C. | 150° C. |
| | PMT in Topcoat | t = 0 | t = 30 min | t = 120 min |
| Sample | Solution (wt %) | (ohms/sq) | (% change) | (% change) |
| Com-7-1 | 0 | 103 | +19 | +39 |
| Com-7-2 | 0 | 67 | +13 | +11 |
| 7-1 | 0.15 | 70 | −2 | +3 |
| 7-2 | 0.15 | 84 | +1 | +1 |
| 7-3 | 0.15 | 122 | 0 | +5 |
| 7-4 | 0.15 | 77 | +2 | +4 |

TABLE XI

| | | | Surface | Surface | Surface | Surface | Surface | Surface |
|---|---|---|---|---|---|---|---|---|
| | | Initial | Resistivity | Resistivity | Resistivity | Resistivity | Resistivity | Resistivity |
| | PMT in | Surface | Change | Change | Change | Change | Change | Change |
| | Topcoat | Resistivity | Desktop | Desktop | Desktop | Desktop | Desktop | Desktop |
| | Solution | t = 0 | t = 1 mos. | t = 2 mos. | t = 3 mos. | t = 4 mos. | t = 5 mos. | t = 6 mos. |
| Sample | (wt %) | (ohms/sq) | (% change) | (% change) | (% change) | (% change) | (% change) | (% change) |
| Com-7-1 | 0 | 103 | +33 | >+2000 | ∞ | ∞ | ∞ | ∞ |
| Com-7-2 | 0 | 67 | +2986 | +2986 | ∞ | ∞ | ∞ | ∞ |
| 7-1 | 0.15 | 70 | +6 | +6 | +13 | +14 | +14 | +20 |
| 7-2 | 0.15 | 84 | +3 | +3 | +4 | +6 | +8 | +12 |
| 7-3 | 0.15 | 122 | +4 | +4 | +11 | +12 | +26 | +30 |
| 7-4 | 0.15 | 77 | +4 | +4 | +10 | +11 | +12 | +14 |

What is claimed:

1. A transparent conductive article comprising:
a transparent support;
at least one first layer disposed on the transparent support, the at least one first layer comprising a network of silver nanowires dispersed within at least one polymer binder; and
at least one second layer disposed adjacent to the at least one first layer, the at least one second layer comprising one or more anticorrosion agents comprising at least one mercaptotetrazole or mercaptotriazole.

2. The transparent conductive film according to claim 1, wherein the at least one second layer is disposed on the at least one first layer.

3. The transparent conductive film according to claim 1, wherein the at least one second layer is disposed between the transparent support and the at least one first layer.

4. The transparent conductive article according to claim 1, wherein the at least one mercaptotetrazole comprises at least one compound having the general structure (I): 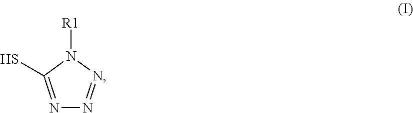
wherein R1 is one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, an amino group (NR₂R₃) where R₂ and R₃ are independently a hydrogen, an alkyl group comprising up to 20 carbon atoms, or an aryl group comprising up to 10 carbon atoms, a thioether group (SR₄) where R₄ is an alkyl group comprising up to 20 carbon atoms, or an aryl group comprising up to 10 carbon atoms, a sulfoxy group (SOR₄), a sulfone group (SO₂R₄), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₂R₃), an acylamino group (NR₂COR₄), an acyl group (COR₄), an acyloxy group (OCOR₄), or a sulfonamido group (SO₂NR₂R₃).

5. The transparent conductive article according to claim 1, wherein the at least one mercaptotetrazole comprises 1-phenyl-1H-tetrazole-5-thiol.

6. The transparent conductive article according to claim 1, wherein the at least one mercaptotriazole comprises at least one compound having the general structure (III): 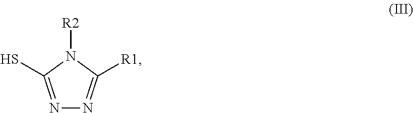
wherein R1 and R2 are independently one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, an amino group (NR₃R₄) where R₃ and R₄ are independently a hydrogen, an alkyl group comprising up to 20 carbon atoms, or an aryl group comprising up to 10 carbon atoms, a thioether group (SR₅) where R₅ is an alkyl group comprising up to 20 carbon atoms, or an aryl group comprising up to 10 carbon atoms, a sulfoxy group (SOR₅), a sulfone group (SO₂R₅), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₃R₄), an acylamino group (NR₄COR₅), an acyl group (COR₅), an acyloxy group (OCOR₅), or a sulfonamido group (SO₂NR₃R₄).

7. The transparent conductive article according to claim 1, wherein the at least one mercaptotriazole comprises 4-benzyl-1,2,4-triazole-3-thiol.

8. The transparent conductive article according to claim 1, wherein the at least one mercaptotriazole comprises 4-benzyl-5-hydroxymethyl-1,2,4-triazole-3-thiol.

9. The transparent conductive article of claim 1, having a transmittance of at least 80% across entire spectrum range of from about 350 nm to about 1100 nm and a surface resistivity of 500 ohm/sq or less.

10. The transparent conductive article of claim 1, wherein the at least one polymer binder comprises gelatin, polyvinyl alcohol, or mixtures thereof.

11. The transparent conductive article of claim 1, wherein the at least one polymer binder comprises cellulose acetate, cellulose acetate butyrate, or cellulose acetate propionate, or mixtures thereof.

12. A method comprising:
applying at least one first coating mixture onto a transparent support to form at least one first coated layer, the at least one first coating mixture comprising silver nanowires and at least one polymer binder; and
applying at least one second coating mixture onto the at least one first coated layer to form at least one second coated layer, the at least one second coating mixture comprising at least one mercaptotetrazole or mercaptotriazole.

13. A method comprising:
applying at least one first coating mixture onto a transparent support to form at least one first coated layer, the at least one first coating mixture comprising at least one mercaptotetrazole or mercaptotriazole; and
applying at least one second coating mixture onto the at least one first coated layer to form at least one second coated layer, the at least one second coating mixture comprising silver nanowires and at least one polymer binder.
